(19) United States
(12) Patent Application Publication
(10) Pub. No.: US 2003/0229596 A1
(43) Pub. Date: Dec. 11, 2003

(54) Method of selected directed giving to an agent within a host effort

(76) Inventor: Byron-Eric Martinez, Half Moon Bay, CA (US)

Correspondence Address: Byron-Eric Martinez, 2004 Touraine Lane, Half Moon Bay, CA, 94019, US

(21) Appl. No.: 10/162,849

(22) Filed: Jun. 6, 2002

(51) Int. Cl. G06F 17/60

(52) U.S. Cl. 705/64

(57) ABSTRACT

General system 10 manages selected giving from a donor 12 for directly funding a licensed or certified individual agent 14 functioning within a host effort The host effort may be a traditional institution such as a school or hospital or church with teachers and doctors and priests on staff. The method of management involves maintaining a directed giving account at financial institution 16, and issuing a trust instrument by which the agent makes disbursements. Funding contributed from the donor are credited to the account, and charges from vendors for disbursements are debited against the account. The financial institution accounts for all transactions and terminates the account and the underlying trust instrument under predetermined conditions.

### TECHNICAL FIELD

This invention relates to selected giving to a work, and more particularly to such giving directly to an effective individual agent within the work.

### BACKGROUND

Philanthropic funding and gifts are commonly given by a collection of unrelated donors to a benevolent works entity such as a school or hospital or church. The funds then trickle down to the agents (teachers, doctors, and priests) working in the field (classrooms, clinics, and parishes). The staff administrators of these entities employ established funding guidelines and distribution procedures. However, these guidelines may not correspond to the priorities of all of the donors. Further the donors may perceive that the staff and the procedures create a burdensome, and costly overhead which reduces the amount of funding available to the field agents.

### SUMMARY

It is therefore an object of this invention to provide a system of selected giving in which funds or credit are directly available to the agent in the field. The funding is channeled to the agent through a donor backed trust instrument (such as a debit card) from a major financial institution (such as a bank). Many donors are be motivated to support charitable works, but may not be entirely in agreement with the philosophy or priorities of the charitable host entity. Further, the donors may question the effectiveness of traditional administration practices which frequently involve burdensome delays and overhead. Directed funding to the field agent through the present method completely eliminates the effect of these existing philosophies, priorities and practices. By employing an underlying trust instrument, one hundred percent of the funding may reach the agent immediately where the funding is needed.

It is another object of this invention to provide such a directed system of selected giving in which the funds may be disbursed at the discretion of the agent in the field. The agent may employ his own priorities, using the existing priorities and practices only as a guideline. The agent in the field has first hand information, and is in a better position to know what is needed and what policies are effective. For example, a group of parents may recognize a particularly effective teacher in a school system. The parents would like that teacher to have discretionary funding for extra supplies, field trips, special projects, etc. A debit card in the name of the teacher, but funded by the parent provides the desired discretion.

It is another object of this invention to provide such a directed system of selected giving in which the funds may be disbursed in minimal amounts by the agent in the field. For example, the computer laboratory needs the latest version of a $10 tutorial. A particularly capable student from a low income situation may need very modest funding to purchase relays and connectors for a science fair project in electronics. Teachers have been known to pay such expenses out of their own modest salary. Debit cards and the like are designed to handle such minimal disbursements. In contrast, large budget educational organizations have difficulty addressing such minor disbursements and minuscule needs of low profile students. These organizations perform much better at large scale aid benefiting all of the students within the system.

It is a further object of this invention to provide such a directed giving system using existing effective economic institutions for managing the funding and disbursements. Modern major financial institutions such as banks and money market funds are organized to routinely handle credit card and debit card matters. These in-place institutions operate huge computer systems which process vast numbers of transactions daily for millions of individual accounts with high accuracy and very low cost per transaction.

It is a further object of this invention to provide such a directed giving system which provides a complete record of all directed giving transactions for inventory control. Such a complete record may be employed to account for the property acquired through the trust. A “mirror” portion of the record concerns private property of the agent which cooperates with the trust property. The record may include identification data for determining ownership and present whereabouts of the property. This trust/agent record distinguishes identified trust property from identified agent property for reducing confusion between the agent's property and the trust assets during the life of the trust.

It is a further object of this invention to provide such a directed giving system which tags contributions from donors and tracks charges from to vendors for increasing the accountability of the agents. The improved accounting discourages misuse of the system by the agents creating a more secure giving environment which encourages directed giving from donors.

It is a further object of this invention to provide such a directed giving system using existing effective government and professional institutions for enforcing the philanthropic standards. State and federal licensing boards and various professional associations, may be employed to censure and if needed suspend the rare misguided agent. Such enforcement is not a burden in time or money to the directed system of giving. The donors merely notify the appropriate authority, provide incriminating documents, and terminate the agent's debit account. Local vendors may be enrolled in this policing effort through tipster channel information on the debit card.

It is a further object of this invention to provide such a directed giving system which requires minimal attention and effort by donor and agent. The financial institution sets-up the account, enters all of the funding gifts and charges, and provides accounts to the donor and agent. The only responsibility the donor has is to donate funds; and the only responsibility the agent has is to disburse the funds.

It is a further object of this invention to provide such a directed giving system which has minimal impact on the administrators and the other agents within the work. The financial institution has the primary responsibilities within the system. The host entity administrators and the other agents may not even be aware of the existence of the account. These administrators and other agents may be shielded from knowledge of the donors and trust instrument because this information is held in confidence. Lack of awareness may reduce political stress within the host entity.

It is a further object of this invention to provide such a directed giving system in which account information is released in news media coverage of social significance events to inform socially responsible donors. The news story publishes sufficient information to enable a stranger donor to deposit a philanthropic or charitable gift into the account. The account may be specially created on the web for electronic transfer of funds. Directed giving may thus be advanced through existing news media without promotional effort by the administrators and agents.

It is a further object of this invention to provide such a directed giving system which traces contributions from multiple donors through multiple channels for permitting donor tracing of the contributions received through each channel. The tracing in accomplished by using multiple pseudo accounts, at least one account for each channel. Tracing through the pseudo accounts facilitates reassigning the funds in the event of termination of the host effort or directed giving account. A change in circumstance such as death of the agent or donor, time expiration of the account, or premature fulfillment of the host effort eliminating the need for continued funding, may trigger the termination and tracing. The funds may be returned to the donors or redirected into another effort, or into a cascading use to a remainderman.

It is a further object of this invention to provide such a directed giving system to encourage effective agents to remain with the host effort. Over the years an effective agent may develop a support base of outside trust funding. The agent may find a feeling of acknowledgement and a wellspring of inspiration in this through funding. In addition, the freedom permitted by the funding enhances the agents freedom and effectiveness. The sources of personal satisfaction may encourage the agent to remain in the field.

It is a further object of this invention to provide such a directed giving system in which the donors receive a tax deduction for their contributions. A governing body with 501(c)(3) status initially receives the funds from the donors, and provides direction to the agents. The financial institution is merely an accounting presence without discretionary power.

Briefly, these and other objects of the present invention are accomplished by providing a method of managing philanthropic and other giving from a donor for directly funding a licensed or certified individual agent functioning within a host effort for furthering the goals of the host effort. A directed giving account is maintained at a financial institution with a balance available for funding the agent's activities. Gifts contributed from the donor are credited to the account. A trust instrument is issued by which the agent makes disbursements in furtherance of the goals of the host effort. The agent may be subject to suspension or loss of license or certification in the event of misuse of the trust instrument. Charges from vendors for disbursements made by the agent are debited against the account. The financial institution provides accounting reporting each charge by amount of the disbursement and subject matter of the disbursement. The account and the trust instrument may be terminated under predetermined conditions.

### BRIEF DESCRIPTION OF THE DRAWINGS

Further objects and advantages of the present method of directed selected giving and the operation and termination of the trust instrument will become apparent from the following detailed description and drawings in which:

FIG. 1 is a block diagram of system 10 showing selected giving by donors 12 to agent 14 through financial institution 16;

FIG. 2 is a block diagram of system 20 showing the selected giving of FIG. 1 directed by a 501 governing body 26G;

FIG. 3 is a block diagram of system 30 showing the selected giving of FIG. 1 with state licensing board 37L, local school board 37B, and tipster channel 37T; and

FIG. 4 is a block diagram of system 40 showing the selected giving of FIG. 1 with tagging and tracking software 47 monitoring contributions and charges.

The first digit of each reference numeral in the above figures indicates the figure in which an element or feature is most prominently shown. The second digit indicates related elements or features, and a final letter (when used) indicates a sub-portion of an element or feature.

### REFERENCE NUMERALS IN DRAWINGS

The table below lists the reference numerals employed in the figures, and identifies the element designated by each numeral.

10 General System 10

12 Donors 12

14 Agent 14

16 Financial Institution 16

18 Commerce 18

20 System 20

22 Donor 22

24 Agent 24

26F Financial Institution 26F

26G Governing Body 26G

27W Web Site 27W

28 Vendors 28

30 System 30

32P Donor Parent 32P

32S Student 32S

34 Teacher 34

36 501 Institution 36

37B School Board 37B

37T Tipster Channel 37T

37L State Licensing Board 37L

38 Local Merchants 38

40 System 40

42 Donor 42

44 Agent 44

46 Financial Institution 46

47 Tagging and Tracking Software 47

48 Vendors 48

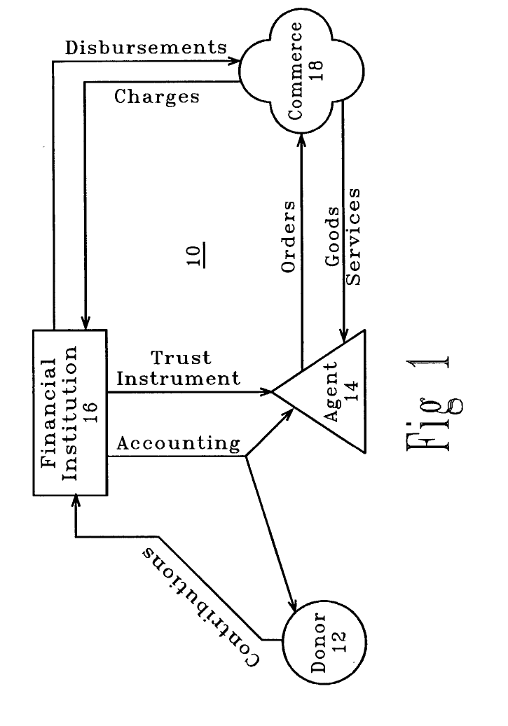

### GENERAL EMBODIMENT (FIG. 1)

General system 10 for managing selected giving from a donor 12 for directly funding individual agent 14 functioning within a host effort is shown in the block diagram of FIG. 1. The donor may be an individual or a corporation or other organization. The host effort may be a traditional institution such as a school or hospital or church with teachers and doctors and priests on staff. The effort may also be an unstructured project organized by a single, free lance operative, such as a non-commercial SAT review course given by a retired algebra teacher to promising, needy students. Further, the effort may be more personal to the donor then purely philanthropic in nature. Each step of the general method of is disclosed below.

Maintaining a directed giving account at a financial institution with a balance available for funding the agent. Financial institution 16 may be any suitable institution such as a major bank or account keeping service which routinely initiates accounts, executes financial transactions, provides records of the accounts and transactions, and otherwise manages the accounts. The financial institution may be an organized group such as a large church or The United Way, in the business of soliciting charitable contributions, and which has sufficient in-house capability to manage the directed giving accounts by means of internal systems or external banking accounts.

Crediting contributions from the donor to the account. The gifts may be cash deposited through the financial institution, or transfer of credit from a donor account or credit card, or the use of a third party credit card (similar to a corporate credit card used by employees). The gift may be simple credit, “in kind” or services. For example, a building supply outlet such as Home Depot may contribute materials to an individual involved in a beneficial effort such as Habitat for Humanity. A more general merchandise outlet such as Costco may contribute blankets, sleeping bags, food, batteries etc. to flood victims. Slow moving inventory may be especially attractive for gifts. An promotional campaign for a non-profit effort may need professional graphic and media consultant services. Various accounting difficulties may be minimized by use of benefactor credit cards, such as a Sears card for tools and a Shell card for gasoline.

Issuing a trust instrument through which the agent makes disbursements in furtherance of the goals of the host effort. The underlying trust instrument may be any suitable funding mechanism such as a credit card, debit card, ATM card (when cash funding is appropriate), bank card, letter of credit etc., which is underwritten by the donor(s). The cards may have a single purchase or transaction limit and/or a total credit limit. The limit on the debit card may be the balance remaining in the account. The charges may be made against the directed giving account on the sole authority of the agent. The charges may be limited to disbursements to approved vendors. That is, the trust instrument may be limited to certain local merchants, retail chain stores, and mail orders supply houses. The general method may include the step of securing an agreement in writing from the agent to the terms and conditions of the trust instrument, and to the consequences of misuse. The directed giving account may be held jointly by the agent and a sponsoring organization for the agent which has a staff to oversee the disbursements. The sponsoring organization may oversee a plurality of sub-accounts within the directed giving account.

Debiting charges from vendors in commerce 18 for disbursements made by the agent against the account. A vendor may be any suitable commercial enterprize such as merchant or business to which the agent may place orders, make purchases, rent or otherwise obtain goods and services useful in furtherance of the goals of the host effort.

Accounting by the financial institution reporting each charge by amount, date, and subject matter of the disbursement. The accounting may involve a database history of all disbursements, credits and other transactions. The account statements may be periodic (such as monthly) or on demand. The account statements may be limited to the recent transactions or may be a complete record covering the entire history of the trust instrument. Such a complete record may be employed in an accounting inventory control step (identifying and tracking) of the property acquired through the trust such as equipment, supplies, durable consumables, leases, contracts etc. The record may have a “mirror” portion containing property acquired privately by the agent which is related or similar to the trust property. Both the trust portion and the agent portion of the record may include product serial numbers and other identifying marks for determining ownership and present whereabouts of an item. This duel record may be employed in the inventory step to distinguish identified trust property from identified agent property. Establishing ownership of related property minimizes confusion between the agent's property and the trust assets during the operation and termination of the trust.

For example, a high school biology teacher may privately purchase a common laboratory microscope (with a serial number) for his own use. The agent enters a description of the asset, the date of purchase, the serial number etc., into the agent portion of the complete record. Later the agent purchases several more identical instruments (with different serial numbers) through the trust for class use. These microscopes are also entered in the record as belonging to the trust. The microscopes become commingled by student use in the classroom. Existence and ownership may easily be determined by comparing the entries in the agent's mirror portion of the record with the regular trust entries. The serial numbers reveal which microscope belongs to the agent.

The accounting procedures and standards employed in conventional expense accounts may be applied to these directed giving accounts. Such accounting techniques are effective even though salesmen type expense accounts are not based on philanthropic giving through a trust instrument, and do not involve a licensed or certified agent.

Terminating the account and the underlying trust instrument under predetermined conditions. The directed giving account and the trust instrument may be unilaterally terminated by the donor and/or the agent and/or the financial institution. Any or all of these parties may have predetermined conditions for termination of the trust instrument. The general method may include the step of placing post termination title to the directed giving account and in the name of the host effort subject to use by the agent until termination. This remaindermen title may include the balance of the directed giving account and the assets acquired through the disbursements from the account. The complete disbursement record statement may be employed at termination to locate and account for existing property of the trust. The complete record may include a “sign-off” form for the convenience of the parties. Certain dedicated assets such as class room equipment and supplies may be subject to a use claim by the agent. After the termination step, the account balance and assets may be either forwarded to the same agent in another host effort, or transferred to another agent in the same host effort or returned to the donor, at the election of the donor. The termination terms and proceeding may be administered through a trust department of the financial institution.

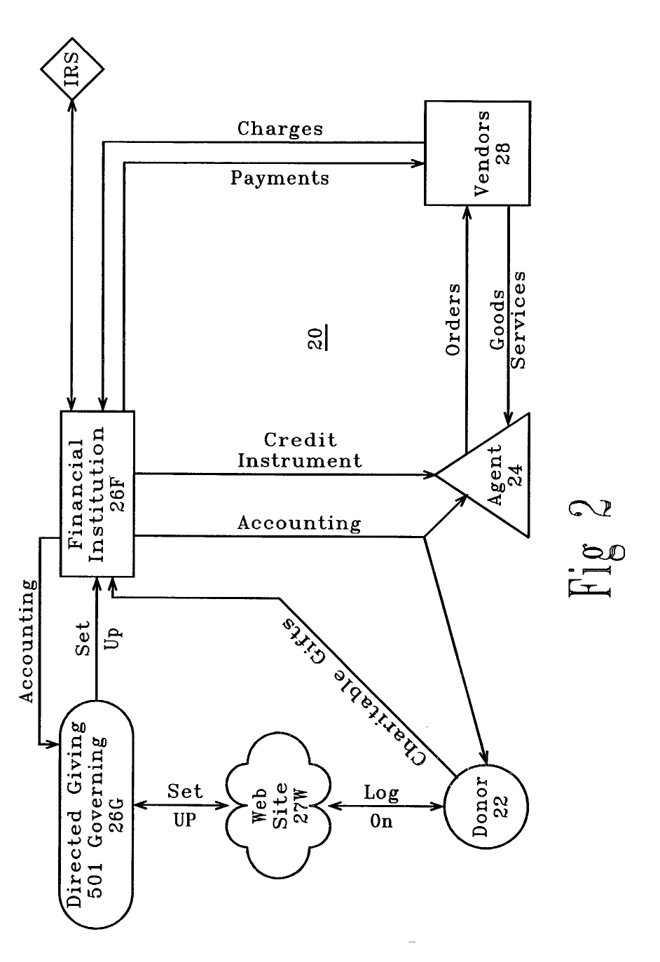

### GOVERNING BODY EMBODIMENT (FIG. 2)

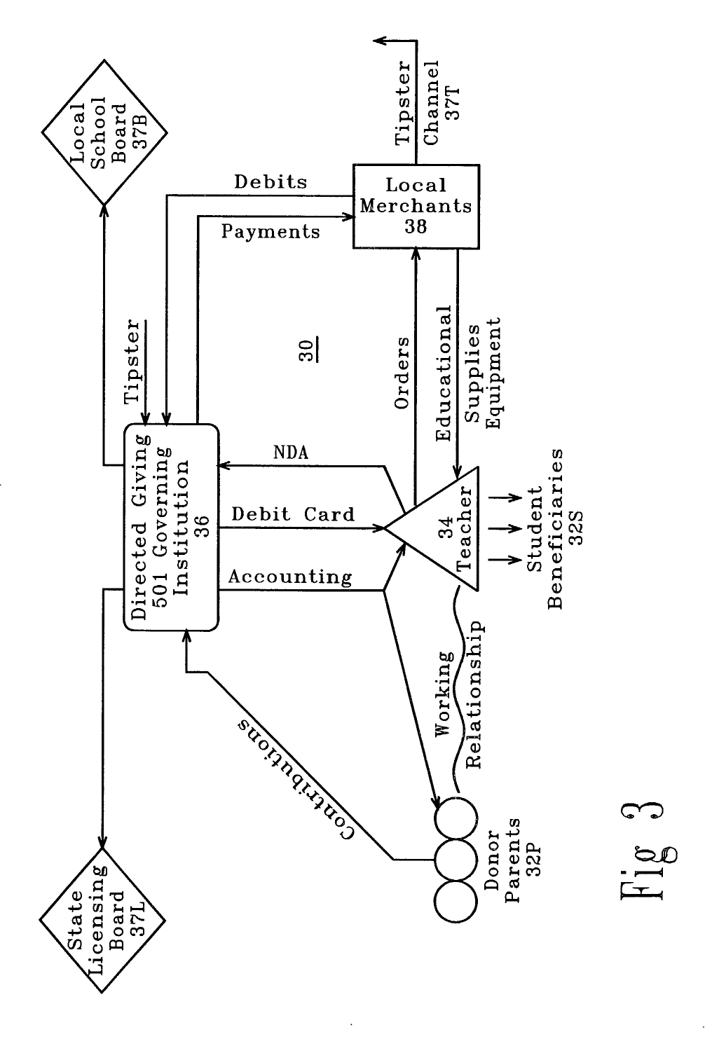

The general method may include the step of providing a governing body between the donor and the financial institution, as shown in system 20 of FIG. 2. Governing body 26G may set-up and oversee the directed giving from donor 22 to agent 24 through financial institution 26F, and execute the accounting step. The financial institution may account to the governing body as well as to the donor(s) and agent(s). The accounting may not be identical to each party. Some parties may not need all of the information or may need expanded information in areas of particular interest. The governing body may be a suitable non-profit foundation, having a 501(c)(3) tax exempt status, establishing a tax deduction for the charitable contribution of the donors. Governing body 26G may be separate from financial institution 26F (shown in FIG. 2), or the governing body may be merged with the financial institution (as indicated by reference numeral 36 in FIG. 3). The general method may include the step of providing IRS charitable tax deduction statements from the financial institution to the donor.

Service Fee

The general method may include the step of charging a service fee paid to the financial institution maintaining the directed giving account. The service fee may be paid by vendors 28 receiving the disbursement payments. The service fee may be based on a percentage (such as 1.5%) of the disbursement charges against the directed giving account. In addition, an accounting fee may be paid from the balance of the directed giving account to the governing body. In addition, a governing fee may be paid to the governing body from the financial institution. This governing fee may be based on a percentage of the charges against the directed giving account, or the fee may be a fixed annual fee. The governing fee may be paid out of the balance of the directed giving account. Preferably, none of the above fees are applied against the donors or agents.

Web Site

Information about the directed giving accounts may be presented on web site 27W (such as directed giving.com) on the internet for general promotion and outreach (shown in FIG. 2). The web site may be managed by the staff of the governing body (or financial institution), or by individual donors and/or agents. Accounting information may be available to the donor(s) and the agent(s) through the web site. Such web distribution provides continuous on demand accounting record without monthly statements or postage. The accounting information may be secured, and not available to general visitors to the web site. Security levels may be assigned requiring identification, passwords, ID numbers, etc. The name or identity of the donor may be confidential and not revealed on the web site. The donor may receive e-mail through the web site and remain anonymous. The agent and/or the governing body, may also receive e-mail through the web site.

Pseudo Accounting

The general method of managing selected directed giving may include the step presenting information about the agent and the host effort to potential donors using a pseudo account with the financial institution. The pseudo account is associated with the directed giving account, for receiving contributions from the potential donors without revealing the directed giving account. The information may be presented to the public through multiple publication channels using multiple pseudo accounts, one account for each channel. The multiple accounts permit tracing of the contributions received through each channel. Each publication channel may initially receive contributions through that channel, and forward the contributions to the host effort. The channels include credit card companies, newspaper agencies, or any collection intermediary authorized to collect funds from donors on behalf of donees, complete with restrictions or tags so that tracking by the financial institution may occur. The information may be presented at a web site associated with the pseudo account, or to a news media for reporting in a news story.

News Publication

A newsworthy philanthropic event of social significance covered by the news media may create interest in potential donors. In addition to the usual story line facts, the media is presented with sufficient information about a directed giving account to enable a stranger donor to deposit funding into the account. The account information may be published as part of the socially interesting coverage. The account and the press release may be set up by the agent or by a public relations arm of a non-profit host organization or related financial institution. The release may include the name of the agent and philanthropic cause, the number of the account, the name and address of the financial institution handling the account, and instructions concerning making a deposit to the account. The release may identify a temporary proxy account to be associated with the directed giving account in due course. The proxy accounts may be generated as required by the media to facilitate meeting “press” deadlines. A proxy account may be part of a master trust account permitting the media to temporarily hold early contributions for many host efforts. The continuous availability of a proxy account permits early contributions to immediately clear the donor's source account, and pass into the directed giving system. These contributions are forwarded to later defined regular directed giving accounts. Alternatively, the release may identify a pseudo account associated with the directed giving account for limiting the exposure of the host effort by preventing fraudulent use of the directed giving account number since, linked proxy or pseudo accounts are only for deposit of funds. The account may be accessible through a web site for instantaneous deposit by electronic delivery or wire transfer of funds. Both the account and web site may be specially created for such charitable events or in response to the news story.

For example, after years of work a dedicated teacher in an inner city school district has developed new approach for teaching children to read. Improved standardized test scores suggest the new approach has great merit but the efforts needs more study and refinement. The news story notes that the teacher does not have a budget for this additional work, and desperately needs funding for classroom equipment which is unavailable through the local school board. Socially responsible members of the public sensitive to education issues may “log-on” to the web site and contribute directly to this teacher's work as a consequence of the account information published in the media coverage. The entire directed giving may be accomplished through the news media without additional promotional effort or expense.

### TEACHER EMBODIMENT (FIG. 3)

System 30 shows a teaching embodiment (see block diagram FIG. 3) in which selected giving from donor parents 32P directly funds individual teacher 34 for the benefit of students 32S. The source of the funding may be a single donor contributing to a directed giving account (shown in FIG. 1) or a plurality of donors (shown in FIG. 3) in working relationship with the teacher. Similarly, the agent may be a single teacher in a classroom or a team of lawyers in a store front law practice. Each donor may retain a continuing ownership interest in their gift until the funding is extinguished through disbursements on a FIFO basis. Under FIFO, early donors lose any remaindermen rights in the balance before later donors. Alternatively, the donor's interest may not be a continuing interest, but is extinguished immediately upon donation. The donors may form a set of subscribing donors, each contributing a specified gift, or pledging such a gift in the future. The gift from each donor may be a single one time gift, or a periodic support gift (such as monthly or annual).

### INDIVIDUAL POLITICAL CONTRIBUTIONS

The structure of an individual political contribution embodiment parallels the structure of the teacher embodiment of FIG. 3. Many donor activists make small political contributions into a directed giving account for the benefit of a special interest, or for the benefit of the public at large (present and future). The candidate politician draws on the account to fund various campaign activities. A donor may tag his contribution restricting the type of campaign activity which is to be funded by that donor. For example, a donor may specify that his contribution is limited to expenses associated with mass mailing information to the public, or excluded from funding any form of TV promotion.

### ENFORCEMENT

Enforcement terms of the trust or credit instrument may be expressed on a small plastic card that the agent presents to a vendor to authorize a purchase or disbursement. The agent making the disbursement is subject to suspension by school board 37B or loss of license or certification from state licensing board 37L (or both) in the event of misuse of the underlying credit instrument. The credit instrument may provide notice to the vendor (and to the agent) stating:

the name of the agent (holder of the credit instrument),

the name of the host organization (backer of the credit instrument),

the license or certification number of the agent (if any),

that the credit instrument is for a directed giving account, and

a warning that misuse of the credit instrument may result in suspension or loss of the agent's license or certification.

A statement such as

“Use of this card for disbursements other than on behalf of the named host organization for the named charitable purpose, may subject the holder of the card to penalties.”

In order to facilitate policing, the trust instrument or card may provide tipster procedures for reporting disbursements which suggest misuse or appear suspicious. Suspect transactions may include the purchase of personal items (clothing, meals, etc.), or activities outside a specified zip code range, or goods exceeding a particular purchase amount. The trust instrument card may specify tipster information including a suitable channel of tipster communication 37T, such as a tipster telephone number (preferably toll-free 800), an e-mail address, or a post office mailing address. Due to limited space, the details of the trust instrument and tipster communication rules and procedures may be presented on a web site or printed in a related hard copy brochure which is mailed to the tipster. Vendor 38 (or other tipster person) may report the suspect disbursement to the financial institution or governing body. The tipster procedure may include securing agreement from the agent to the conditions of the trust instrument including the consequences of misuse.

### FILTERING

The general method may include the step of filtering the charges against the directed giving account for disbursements which suggest misuse or appear suspicious, to discourage misuse of the account by the agent. The filtering may be done visually by accounting personnel or automatically by a computer employing disbursement filtering software with a key word database.

### ACCOUNTING

During the accounting step the balance of the directed giving account may be reported to the donor and/or the agent. The host effort may be notified of the existence of the directed giving account and the trust underlying instrument. Full knowledge by all parties may lessen political stress between the host effort (and non-involved agents) and the donors (and involved agents). The financial institution may account to the host effort, reporting each charge by amount of the disbursement and subject matter of the disbursement. Alternatively, the accounting may be reported only to the agent and the donor, and not reported to the host effort or to any other agents within the host effort. The identity of the donor may be confidential and not to be revealed by the financial institution to the host effort or to any of the non-involved agents. The identity of donor may be so confidential that the financial institution may not even revealed this identity to the agent. Further, even the fact that the directed giving account exists may be confidential, and disclosed only on a need to know basis. In this secret environment the financial institution may not generally reveal any information about the account. The secrecy requirements may be facilitated by the step of securing a non-disclosure agreement (NDA) in writing from the agent in which the agent agrees not to disclose information about the directed giving account, subject to loss of funding. Under such an agreement the agent may not in general discuss account matters and may not disclose information to others including the school board and the media. This secrecy/loss provision keeps the account in a low profile and also may shield agent from external pressure to disclose.

### INTEGRATED ACCOUNTING

Integrated accounting or backend financial systems such as Avelant and other management type programs may be employed to assist the donor in selecting a donee and maintaining a record of the donor's directed giving gifts. These systems connect and facilitate transactions between corporate compensation, employee benefits (including matching funds for charitable donations), banking and tax reporting. Companies and other employers may establish a seamless interface between these activities, so that the employee may easily manages directed giving and other financial matters from a PDA, desktop or mobile PC. The employee donor may conveniently view his financial resources and entire monetary situation including his assets (bank accounts, stock portfolio, 401K status etc.), his current credit situation (credit card balance, home mortgage, automobile loans etc.) payroll information, and his charitable contribution history. The donor may draw information and facts from a combination of data sources such as his portion of the corporate benefit database, the internet, and his own personal data records. The corporate database may indicate whether a donee candidate has 501(c)(3) status (or other applicable section governing gifts in the tax code) with the IRS and whether the corporation will provide matching funds.

A computer desktop directed giving sequence involving the internet the above integrated accounting data sources may transpire as follows:

(a) The donor finds a news article from CNN (or other news service) or a promotion web site of interest through a search engine.

(b) The article identifies the donee's directed giving account (including by proxy or pseudo account numbers) for the destination of the gift funds.

(c) The donor enters his gift and the donee account number on a pull-down donation screen. The account number may be copied directly from the article into the donation screen by “click and copy”.

(d) The screen provides basic information from the account alphanumerics about the destination charity, such as charitable status, possible matching funds, etc.

(e) The donors financial resources are noted as possible sources for the gift.

(f) Confirmation of the gift is received (printed out) by the donor.

(g) Additional material concerning the charity is emailed (or otherwise provided) to the donor.

(h) Accounting for the use of the funds is e-mailed (or otherwise sent) to the donor.

(i) End-of-year tax reporting is documented along with salary history and stock events.

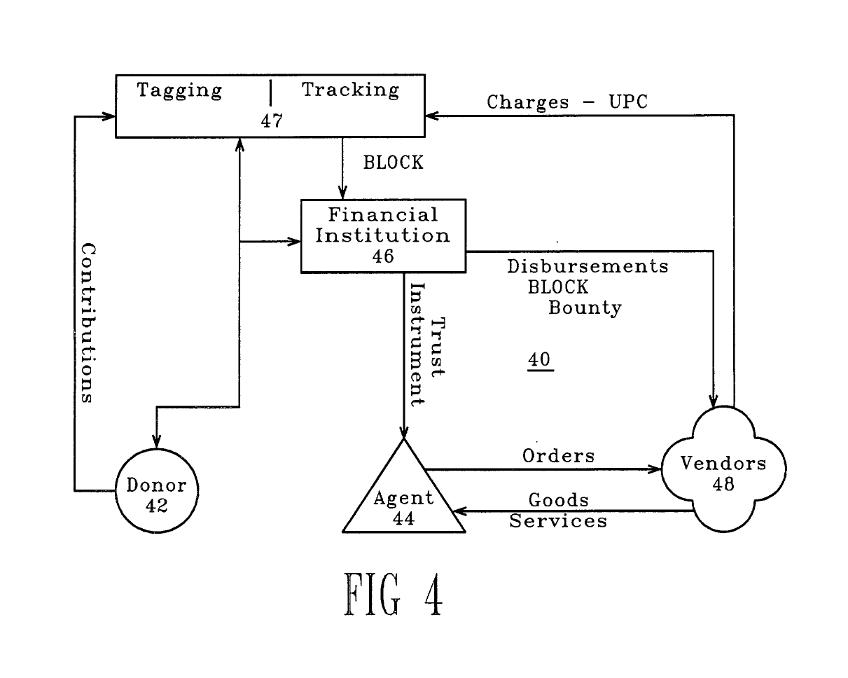

### TAGGING AND TRACKING (FIG. 4)

The general method of managing selected directed giving may include the steps of:

tagging the contributions for a predetermined category or categories of host effort goals, and

tracking the disbursement charges by amount of the disbursement and subject matter of the disbursement.

Donor (or donors) 42 specify the intended use, and any limitations or restrictions of the funds. The details of this tagging and tracking may be presented to agent (or agents) 44 in general guidelines for the directed giving or in a formal contract between the donor and agent. The information is entered into an accounting note or electronic tag which follows the funds through the directed giving process. The funds are then tracked through the debiting and accounting steps to insure that the funds have not been misused. The tagging and tracking may be done manually by hand-entries in the accounts and by hand-sorting through the charges and receipts from vendors 48. Alternatively, the tagging and tracking may be done automatically by computer programs 47, which tag the incoming funds and detect the amount of the disbursements and the category of the goods and services. The tagging and tracking may be performed by financial institution 46 as part of the provided service. The tagging and tagging may be done privately without a service fee by the donor and/or agent using personal computers.

In order to promote orderly tagging and tracking, the charges to the directed giving account may be limited to disbursements from approved vendors. A single field of commerce or a single store or chain within a field of commerce may be exclusively authorized to accept charges. For example, in a construction project, all building materials must be purchased from major supply house such as “Home Depot”. The charges to the directed giving account may be limited to disbursements which do not exceed a predetermined amount and involve only goods and/or services having predetermined product codes. Universal product codes (UPCs) or codes defined within a certain commercial field or retail outlet may be employed. These codes may appear on the charge receipt for electronically scanning or otherwise entered into the tagging/tracking cycle.

Each host effort may have a standard restriction list of goods and services unique to that effort. The list for educational efforts may be limited to such items as text books, class room supplies, and various lunch or snack programs. Certain items may be universally rejected as outside the scope of the host efforts, such as liquor, travel, food and cash.

Blocking

The general method may also include the step of blocking the disbursement at the vendor's point of sale for a good and/or service which exceeds the predetermined amount or does not have a predetermined product code. The charge may be electronically blocked in real-time at the point-of-sale by a BLOCK signal starting from tagging and tracking program 47 and forwarded to vendor 48 through financial institution 46. Such a blocked charge does not pass through the system, and is similar to an over limit or an expired card situation. In one embodiment, the directed giving account is terminated and the vendor may keep the card for a bounty from the financial institution.

### CONCLUSION

It will be apparent to those skilled in the art that the objects of this invention have been achieved as described hereinbefore. Clearly various changes may be made in the structure and embodiments shown herein without departing from the concept of the invention. For example the enforcement and tipster features of the embodiment shown in FIG. 3 embodiment may be employed in the general embodiment shown in FIG. 1. Further, features of the embodiments shown in the various figures may be employed with the embodiments shown in the other figures. Therefore, the scope of the invention is to be determined by the terminology of the following claims and the legal equivalents thereof.

I claim as my invention:

1) A method of managing selected giving from a donor for directly funding an individual agent functioning within a host effort, for furthering the goals of the host effort, comprising the steps of:
maintaining a directed giving account at a financial institution with a balance available for funding the agent;
crediting funding contributed from the donor to the account;
issuing a trust instrument through which the agent makes disbursements to vendors in furtherance of the goals of the host effort;
debiting charges from vendors for disbursements made by the agent against the account;
accounting to the donor by the financial institution, reporting each charge by amount of the disbursement and subject matter of the disbursement; and
terminating the account and the trust instrument under predetermined conditions.

2) The method of claim 1, further comprising the additional step of notifying the host effort of the existence of the directed giving account and the trust instrument.

3) The method of claim 2, wherein the accounting by the financial institution is also reported to the host effort.

4) The method of claim 1, wherein the accounting by the financial institution is reported only to the agent and the donor, and is not reported to the host effort or to any other agents within the host effort.

5) The method of claim 1, wherein the identity of the donor is confidential and may not be revealed by the financial institution.

6) The method of claim 1, wherein the fact that the directed giving account exists is confidential and may not be revealed by the financial institution to any officials of the effort or to any other agents within the effort.

7) The method of claim 1, further comprising the additional step of securing a non-disclosure agreement in writing from the agent in which the agent agrees not to disclose information about the directed giving account, subject to loss of funding.

8) The method of claim 1, further comprising the additional step of charging a service fee paid by the vendors receiving the disbursements to the financial institution, based on a percentage of the charges against the directed giving account.

9) The method of claim 1, wherein the directed giving account is jointly held by the agent and a sponsoring organization for the agent which has a staff to oversee the disbursements.

10) The method of claim 9, wherein the sponsoring organization oversees a plurality of sub-accounts within the directed giving account.

11) The method of claim 1, wherein the donor is a plurality of donors contributing to the directed giving account.

12) The method of claim 11, wherein each donor's interest in their contribution is extinguished as the funds are disbursed on a FIFO basis.

13) The method of claim 1, wherein the accounting step further includes providing a complete record of the disbursement history of the trust instrument.

14) The method of claim 13:
wherein the complete record identifies property acquired through the trust; and
the accounting step includes providing an inventory of the identified trust property.

15) The method of claim 13:
wherein the complete record identifies property acquired through the trust and related property acquired privately by the agent; and
the accounting step includes providing an inventory of the identified trust property and the identified agent property.

16) The method of claim 1, further comprising the additional step of filtering the charges against the directed giving account for disbursements which suggest misuse to discourage misuse of the account by the agent.

17) The method of claim 1, wherein the individual agent is licensed or certified to operate within the host effort, and subject to suspension or loss of license or certification in the event of misuse of the trust instrument.

18) The method of claim 17, wherein the trust instrument states the name of the agent, the license or certification number of the agent, that the trust instrument is for the directed giving account, and a warning that misuse of the trust instrument may result in suspension or loss of the agent's license or certification or the right to participate in directed funding by the donor.

19) The method of claim 18, further comprising the additional step of providing a tipster channel of communication for permitting the reporting of disbursements which suggest misuse.

20) The method of claim 19, wherein the trust instrument specifies the tipster channel of communication.

21) The method of claim 17, further comprising the additional step of securing an agreement in writing from the agent to the terms and conditions of the trust instrument and to the consequences of misuse.

22) The method of claim 17, wherein charges may be made against the directed giving account on the sole authority of the agent.

23) The method of claim 1, further comprising the additional step of
providing a governing body between the donor and the financial institution, for setting up and maintaining the directed giving account.

24) The method of claim 23, wherein the accounting step is executed by the financial institution to the governing body.

25) The method of claim 23, wherein the governing body is a non-profit foundation.

26) The method of claim 25, wherein the non-profit governing body has 501(c)(3) tax exempt status, establishing a tax deduction for charitable contribution of the donors.

27) The Method of claim 26, further comprising the additional step of providing charitable tax deduction statements from the financial institution to the donor.

28) The method of claim 23, further comprising the additional step of paying the governing body a governing fee.

29) The method of claim 28, wherein the governing fee is from the financial institution, and is based on a percentage of the charges against the directed giving account.

30) The method of claim 28, wherein the governing fee is paid out of the balance of the directed giving account.

31) The method of claim 23, wherein the governing body operates a directed giving web site on the internet.

32) The method of claim 31, wherein the accounting information is available to the donor and the agent through the web site.

33) The method of claim 32, wherein the web site is presented to the general public, and the accounting information is secured, and not available to general visitors to the web site.

34) The method of claim 32, wherein the identity of the donor is not revealed on the web site.

35) The method of claim 32, wherein the donor and/or the agent and/or the governing body, may receive e-mail through the web site.

36) A method of claim 1 further comprising the additional step of
presenting information about the agent and the host effort to potential donors using a pseudo account with the financial institution which is associated with the directed giving account, for receiving contributions from the potential donors without revealing the directed giving account.

37) The method of claim 36, wherein the information is presented to the public through multiple publication channels using multiple pseudo accounts, one account for each channel, for permitting tracing of the contributions received through each channel.

38) The method of claim 37, wherein each publication channel initially receives the contributions through that channel, and forwards the contributions to the host effort.

39) The method of claim 36, wherein the information is presented to a news media for reporting in a news story.

40) The method of claim 36, wherein the information is presented a web site associated with the pseudo account.

41) The method of claim 1, further comprising the additional steps of;
tagging the contributions for a predetermined category or categories of host effort goals; and
tracking the disbursement charges by amount of the disbursement and subject matter of the disbursement.

42) The method of claim 41, wherein the charges to the directed giving account are limited to disbursements from approved vendors.

43) The method of claim 41, wherein the charges to the directed giving account are limited to disbursements which do not exceed a predetermined amount and involve goods and/or services having predetermined product codes.

44) The method of claim 43, further comprising the additional step of blocking the disbursement at the vendor's point of sale for any good and/or service which exceeds the predetermined amount or does not have a predetermined product code.

45) A computer readable medium containing a computer program that manages selected giving from a donor for directly funding a licensed or certified individual agent functioning within a host effort for furthering the goals of the host effort, by directing a computer to execute the steps of:
maintaining a directed giving account at a financial institution with a balance available for funding the agent;
crediting funding contributed from the donor to the account;
issuing a trust instrument by which the agent makes disbursements in furtherance of the goals of the host effort, subject to suspension or loss of license or certification in the event of misuse of the trust instrument;
debiting charges from vendors for disbursements made by the agent against the account;
accounting by the financial institution reporting each charge by amount of the disbursement and subject matter of the disbursement; and
terminating the account and the trust instrument under predetermined conditions.
